(19) United States
(12) Patent Application Publication
(10) Pub. No.: US 2016/0292210 A1
(43) Pub. Date: Oct. 6, 2016

(54) SYSTEM AND METHOD FOR AUTOMATICALLY AND EFFICIENTLY VALIDATING DATABASE OBJECTS

(71) Applicant: Cognizant Technology Solutions India Pvt. Ltd., Chennai (IN)

(72) Inventors: Avadhoot Panse, Pune (IN); Manish Kulkarni, Pune (IN)

(21) Appl. No.: 14/858,327

(22) Filed: Sep. 18, 2015

(30) Foreign Application Priority Data
Apr. 6, 2015 (IN) 1811/CHE/2015

(51) Int. Cl. G06F 17/30

(52) U.S. Cl. CPC G06F 17/30371; G06F 17/3051

(57) ABSTRACT

A system and computer-implemented method for validating one or more database objects is provided. The system comprises an application, residing on one or more client devices, configured to establish a connection with a validation module and scan one or more databases connected to the validation module. Further, the validation module comprises a schema look-up module configured to identify one or more database objects from the one or more scanned databases. The validation module further comprises a parameterization module to facilitate selection of a validation mode and provide one or more input parameters based on the selected validation mode. Furthermore, the validation module comprises an execution engine configured to execute the one or more identified database objects using the one or more provided input parameters and generate validation results. In addition, the validation module comprises a reporting module configured to generate one or more validation reports using the generated validation results.

### CROSS REFERENCE TO RELATED APPLICATION

This application is related to and claims the benefit of Indian Patent Application No. 1811/CHE/2015 filed on Apr. 6, 2015, the contents of which are herein incorporated by reference in their entirety.

### FIELD OF THE INVENTION

The present invention relates generally to validating database objects. More particularly, the present invention provides a system and method for automatically and efficiently validating all database objects.

### BACKGROUND OF THE INVENTION

Many organizations/enterprises maintain and store large volumes of data typically in the form of database objects. A database object is a data structure in a relational database that is used to store or reference data. Database objects are critical and integral part of any database. Most critical business logic resides in the form of various database objects for many mid and large scale applications. Hence, validation of the database objects is very important for organizations that handle thousands of database objects of varied functions and behavior for carrying out their businesses. Further, validation of the database objects facilitate trapping errors and bugs which otherwise would result in failure during operations and may leave the database in an inconsistent state. Also, validation of the database objects is crucial during application migration scenarios to ensure that the migrated database objects function as expected and have not developed any errors or bugs in the new database environment.

Conventionally, various systems and methods exist for validating database objects. For example, database objects are validated manually. However, manual testing is a cumbersome process and requires lot of time and effort specially for testing large scale databases. Further lack of user friendly Graphical User Interface (GUI) makes manual testing even more cumbersome.

Various solutions exist that facilitate automated validation and testing of databases to overcome the above mentioned disadvantages. However, these solutions only validate databases that do not perform real time transactions. These solutions do not validate database objects. Typically, unit testing is performed for validating the database objects that support business logic and real time transactions. However, unit testing of the database objects also suffers from several disadvantages. Unit testing is mostly manual. Further, unit testing is time consuming and expensive. Furthermore, business logic is built into the systems fairly early in the project development lifecycle; however, testing of database objects supporting the business logic is done much later in the project development lifecycle which results in late detection of errors thereby increasing risks and costs. Moreover, database objects are often dynamic and require multiple testing.

In light of the abovementioned disadvantages, there is a need for a system and method for automatically and efficiently validating database objects. Further, there is a need for a system and method that is capable of automatically identifying and validating database objects across multiple databases. Furthermore, there is a need for a system and method that is capable of automatically generating input parameters for validating database objects. Also, there is a need for a system and method that has a user friendly GUI, provides detailed validation reports and is cost and time efficient. In addition, there is a need for a system and method that facilitates the users to easily configure test scenarios.

### SUMMARY OF THE INVENTION

A system, computer-implemented method and computer program product for validating one or more database objects is provided. The system comprises an application, residing on one or more client devices, configured to establish a connection with a validation module and further configured to scan one or more databases connected to the validation module. Further, the validation module comprises a schema look-up module configured to identify one or more database objects from the one or more scanned databases. The validation module further comprises a parameterization module configured to facilitate selection of a validation mode and further configured to provide one or more input parameters based on the selected validation mode. Furthermore, the validation module comprises an execution engine configured to execute the one or more identified database objects using the one or more provided input parameters and generate validation results, wherein the generated validation results comprise execution status of each of the one or more executed database objects. The validation module also comprises a reporting module configured to generate one or more validation reports using the generated validation results.

In an embodiment of the present invention, the one or more database objects include: stored procedures, functions, views, triggers, sequences, indexes, tables and any other database objects. In an embodiment of the present invention, the validation mode selected is at least one of: manual, reference file and automatic. In an embodiment of the present invention, the one or more input parameters are generated by the parameterization module using one or more pre-defined functions if automatic validation mode is selected. In an embodiment of the present invention, the one or more input parameters are extracted from a pre-stored reference file if the reference file validation mode is selected. In an embodiment of the present invention, the one or more input parameters are provided by one or more users if manual validation mode is selected.

In an embodiment of the present invention, data type of the one or more input parameters include: number, float, character, variable character, date and timestamp. In an embodiment of the present invention, the database object is valid if the database object is executed successfully. In an embodiment of the present invention, the one or more client devices include desktops, laptops, palmtops, netbooks, mobile phones, tablets and Personal Digital Assistants (PDAs). In an embodiment of the present invention, the one or more generated validation reports include: database name, date and time of validation, number of objects validated, number of failed or invalid objects, object name, object type, execution status and validation mode.

The computer-implemented method for validating one or more database objects, via program instructions stored in a memory and executed by a processor, comprises establishing a connection with a validation module using one or more client devices. The computer-implemented method further comprises scanning one or more databases connected to the validation module. The computer-implemented method further comprises identifying one or more database objects from the one or more scanned databases. Furthermore, the computer-implemented method comprises selecting a validation mode. The computer-implemented method also comprises providing one or more input parameters based on the selected validation mode. In addition, the computer-implemented method comprises executing the one or more identified database objects using the one or more provided input parameters. The computer-implemented method further comprises generating validation results, wherein the generated validation results comprise execution status of each of the one or more executed database objects. The computer-implemented method also comprises generating one or more validation reports using the generated validation results.

The computer program product for validating one or more database objects comprises a non-transitory computer-readable medium having computer-readable program code stored thereon, the computer-readable program code comprising instructions that when executed by a processor, cause the processor to establish a connection with a validation module using one or more client devices. The processor further scans one or more databases connected to the validation module. Furthermore, the processor identifies one or more database objects from the one or more scanned databases. The processor also selects a validation mode. In addition, the processor provides one or more input parameters based on the selected validation mode. Further, the processor executes the one or more identified database objects using the one or more provided input parameters. Furthermore, the processor generates validation results, wherein the generated validation results comprise execution status of each of the one or more executed database objects. Also, the processor generates one or more validation reports using the generated validation results.

### BRIEF DESCRIPTION OF THE ACCOMPANYING DRAWINGS

The present invention is described by way of embodiments illustrated in the accompanying drawings wherein:

FIG. 1 is a block diagram illustrating a system for automatically and efficiently validating database objects, in accordance with an embodiment of the present invention;

FIGS. 2A and 2B represent a flowchart illustrating a method for automatically and efficiently validating database objects, in accordance with an embodiment of the present invention; and

FIG. 3 illustrates an exemplary computer system in which various embodiments of the present invention may be implemented.

### DETAILED DESCRIPTION OF THE INVENTION

A system and method for automatically and efficiently validating database objects is described herein. The invention provides for a system and method that is capable of identifying and validating database objects across multiple databases. The invention further provides a system and method which is capable of automatically generating input parameters for validating database objects. Furthermore, the invention provides for a system and method that has a user friendly GUI, provides detailed validation reports and is cost and time efficient. The invention also provides a system and method that facilitates the users to easily configure test scenarios.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

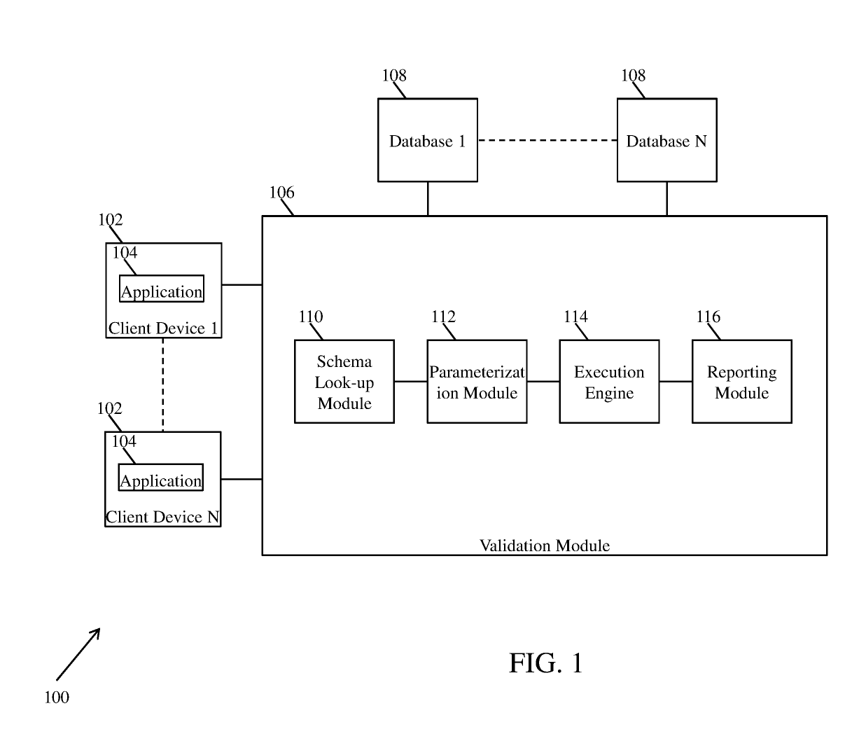

FIG. 1 is a block diagram illustrating a system 100 for automatically and efficiently validating database objects, in accordance with an embodiment of the present invention. The system 100 comprises one or more client devices 102, a validation module 106 and one or more databases 108. The validation module 106 further comprises a schema look-up module 110, a parameterization module 112, an execution engine 114 and a reporting module 116. In an embodiment of the present invention, the system 100 has a two tier architecture wherein the one or more client devices 102 interact directly with the validation module 106.

The one or more client devices 102 are configured to facilitate one or more users to access the validation module 106 via an application 104. In an embodiment of the present invention, the one or more client devices 102 include, but not limited to, desktops, laptops, palmtops, netbooks, mobile phones, tablets and Personal Digital Assistants (PDAs). In an embodiment of the present invention, the one or more users include, but not limited to, testers, software developers and quality analysts involved in project development lifecycle.

The application 104 is configured to establish a connection and facilitate interaction with the validation module 106. The application 104 is further configured to facilitate the one or more users to access the one or more databases 108. In an embodiment of the present invention, the application 104 is pre-installed on the one or more client devices 102. In another embodiment of the present invention, the application 104 is hosted on a remote server and can be accessed by the one or more client devices 102 using Internet Protocol address. In an embodiment of the present invention, the one or more users provide authentication details to access the application 104.

The application 104 automatically scans the one or more databases 108 connected to the validation module 106. On accessing the application 104, the one or more users can view the scanned one or more databases 108. The one or more databases 108 act as a repository for data associated with an organization/enterprise. In an embodiment of the present invention, the one or more databases 108 include, but not limited to, Relational Database Management Systems (RDBMS) such as Structured Query Language (SQL) server, Oracle server, Sybase and DB2 and large databases such as Teradata. Further, the one or more databases 108 comprise one or more database objects. The one or more database objects are data structures used to either store data or reference the stored data in the one or more databases 108. Further, there are different types of database objects such as, but not limited to, stored procedures, functions, views, triggers, sequences, indexes and tables that are used for different purposes and functions in the one or more databases 108.

On viewing the scanned one or more databases 108, the one or more users select the one or more databases 108 that are required to be validated. In an embodiment of the present invention, the one or more users are prompted to provide authentication details associated with the one or more selected databases 108 to access the one or more selected databases 108.

The schema look-up module 110 is configured to scan the one or more selected databases 108 and identify all the database objects associated with the one or more selected databases 108. In an embodiment of the present invention, the schema look-up module 110 scans database schemas of the one or more selected databases 108 and identifies the one or more database objects within the scanned database schemas. In an embodiment of the present invention, the one or more database objects are grouped together based on the type of the database object by the schema look-up module 110. In another embodiment of the present invention, the database objects are listed alphabetically. In an embodiment of the present invention, once all the database objects associated with the one or more selected databases 108 are identified, a list of the one or more identified database objects is rendered on the one or more client devices 102. The one or more users are then prompted to select the one or more identified database objects that are required to be validated from the list. In another embodiment of the present invention, all the identified database objects are automatically selected for validation.

Once the one or more identified database objects to be validated are selected, the control is transferred to the parameterization module 112.

The parameterization module 112 is configured to facilitate selection of the validation mode for validating the one or more selected database objects. The parameterization module 112 is further configured to provide input parameters based on the selected validation mode. The parameterization module 112 provides various modes including, but not limited to, manual mode, reference file mode and automatic mode for validation. In an embodiment of the present invention, the parameterization module 112 is configured to automatically select the “automatic validation mode” for all database objects unless the one or more users select any other validation modes.

In an embodiment of the present invention, if the one or more users select the “manual validation mode”, then the one or more users are prompted to provide one or more input parameters of the selected database object based on data type of the one or more input parameters. In an embodiment of the present invention, various data types for the one or more input parameters include, but not limited to, number, character, variable character, float, date and timestamp. The one or more input parameters provided by the one or more users are received by the parameterization module 112 and forwarded to the execution engine 114 during validation. In an embodiment of the present invention, if the one or more users provide incorrect data type of the one or more input parameters, then the parameterization module 112 renders an error message on the one or more client devices 102 via the application 104.

In an embodiment of the present invention, if the one or more users select the “reference file validation mode”, then the one or more users are prompted to choose and upload one or more reference files. In an embodiment of the present invention, the one or more reference files are Extensible Markup Language (XML) files. In an embodiment of the present invention, the one or more reference files are generated by storing information related to the one or more database objects that were validated previously using the “manual validation mode”. The information related to the one or more database objects stored in the one or more reference files include, but not limited to, database object types, names, input parameters entered by the one or more users and output parameters generated on validation. During the “reference file validation mode”, the parameterization module 112 extracts and provides the one or more input parameters from the uploaded one or more reference files to the one or more users via the application 104. The extracted one or more input parameters are also provided to the execution engine 114 for use during validation. Further, the parameterization module 112 facilitates in rendering appropriate error messages in case the one or more input parameters for the one or more selected database objects are not available in the uploaded one or more reference files.

In an embodiment of the present invention, if the “automatic validation mode” is selected, then the parameterization module 112 uses one or more pre-defined functions for generating the one or more input parameters of the one or more selected database objects. The one or more pre-defined functions are sub-routines stored in the parameterization module 112.

During operation, the parameterization module 112 first queries the one or more databases 108 for determining the type of the one or more selected database objects to be validated. The parameterization module 112 then determines the data type of the one or more input parameters and one or more output parameters of the one or more selected database objects. The parameterization module 112 then uses the one or more pre-defined functions for generating values of the one or more input parameters based on the determined data type.

In an exemplary embodiment of the present invention, for Oracle Server, numeric input parameters are generated using a pre-defined function “rand.nextInt(max)”, wherein “max” is the limit of the function “rand.nextInt(max)”. Similarly for generating a Character or a float or a date value as an input parameter, a different pre-defined function is used by the parameterization module 112. In an embodiment of the present invention, the one or more users can configure the one or more pre-defined functions and modify limits assigned to the one or more pre-defined functions by accessing one or more XML files in which the limits are stored.

Once the validation mode is selected, the control transfers to the execution engine 114. The execution engine 114 is configured to validate the one or more selected database objects and generate validation results. In an embodiment of the present invention, if the “manual validation mode” is selected then the execution engine 114 uses the one or more input parameters provided by the parameterization module 112 for validation. In another embodiment of the present invention, if the “reference file validation mode” is selected then the one or more input parameters extracted from the one or more reference files, by the parameterization module 112, are used for validation. In yet another embodiment of the present invention, if the “automatic validation mode” is selected, then the execution engine 114 is configured to communicate with the parameterization module 112 for generating the one or more input parameters using the one or more pre-defined functions stored in the parameterization module 112. The execution engine 114 validates the one or more selected database objects by executing the one or more selected database objects using the one or more input parameters. In an embodiment of the present invention, the execution engine 114 automatically initiates execution of all the selected database objects simultaneously using the one or more input parameters. In another embodiment of the present invention, the one or more users have an option to selectively initiate execution of a particular type of database objects or a group of database objects.

In an exemplary embodiment of the present invention, for validating the one or more database objects of an Oracle server, the execution engine 114 queries the system table “USER_OBJECTS” of the Oracle Server and determines the object type for the database object to be validated. In an exemplary embodiment of the present invention, the system table “USER_OBJECTS” contains the following columns: “OBJECT_NAME”, “SUBOBJECT_TYPE”, “OBJECT_ID”, “DATA_OBJECT_ID”, “OBJECT_TYPE”, “CREATED”, “LAST_DDL_TIME”, “TIMESTAMP”, “STATUS”, “TEMPORARY”, “GENERATED” and “SECONDARY” as illustrated below.

| OBJECT_NAME | SUBOBJECT_TYPE | OBJECT_ID | DATA_OBJECT_ID | OBJECT_TYPE | CREATED | LAST_DDL_TIME |
|---|---|---|---|---|---|---|
| INSERT_HISTORY | — | 14670 | — | TRIGGER | 01-APR-2014 | 01-APR-2014 |
| ADD_FUNCTION | — | 14671 | — | FUNCTION | 25-APR-2014 | 25-APR-2014 |
| SQUARE_FUNCTION | — | 13547 | — | FUNCTION | 07-APR-2014 | 07-APR-2014 |

| OBJECT_NAME | TIMESTAMP | STATUS | TEMPORARY | GENERATED | SECONDARY |
|---|---|---|---|---|---|
| INSERT_HISTORY | 2014-04-01:15:03:47 | VALD | N | N | N |
| ADD_FUNCTION | 2014-04-25:17:13:40 | VALD | N | N | N |
| SQUARE_FUNCTION | 2014-04-07:11:44:40 | VALD | N | N | N |

To validate the database object ADD_FUNCTION, the execution engine 114 first uses the following query to determine that the database object ADD_FUNCTION is a function.
Select OBJECT_TYPE from USER_OBJECTS where OBJECT_NAME=‘ADD_FUNCTION’
The execution engine 114 then uses the following query to determine the data type of the one or more input parameters associated with the “ADD_FUNCTION”.
Select sequence, in_out, data_type from SYS.ALL_ARGUMENTS where object_name=‘ADD_FUNCTION’ order by position;
In an exemplary embodiment of the present invention, the system table “SYS.ALL_ARGUMENTS”, mentioned in the query above, contains 25 different columns that provide all the information regarding arguments of a database object. The above-mentioned query is used for determining the data type of the one or more input parameters and the one or more output parameters for the ADD_FUNCTION. The execution engine 114, using the above-mentioned query, determines that the ADD_FUNCTION has two input parameters and one output parameter. Both the input and output parameters can have numeric values as shown in the result of the above mentioned query illustrated below:

| SEQUENCE | IN_OUT | DATA_TYPE |
|---|---|---|
| 1 | OUT | NUMBER |
| 2 | IN | NUMBER |
| 3 | IN | NUMBER |

Once the data type of the two input parameters and one output parameter are determined, the execution engine 114 facilitates generating values of the two input parameters for use during validation of the “ADD_FUNCTION”.

In “automatic validation mode”, the two input parameters are generated automatically using the one or more pre-defined functions assigned for generating numeric values for the input parameters that have numeric data type. There are different pre-defined functions assigned for generating input parameters having data type other than numbers. For validating the “ADD_FUNCTION”, the pre-defined function “rand.nextInt(max)” is used to generate numeric input parameters, wherein “max” is a pre-defined upper limit for generating a random number. In an embodiment of the present invention, the one or more users can configure the pre-defined function “rand.nextInt(max)” and modify the value assigned to “max” by accessing the XML file in which the value of “max” is stored. There are two input parameters of the “ADD_FUNCTION”. The “rand.nextInt(max)” function is executed twice to generate two numbers; for example 147 and 270.

In “manual validation mode”, the one or more user enters the input parameters for the ADD_FUNCTION. For example, the user enters 147 and 270. Further, the one or more users cannot execute the ADD_FUNCTION for validation unless the values entered are correct for all the input parameters associated with the ADD_FUNCTION. For example, if the user enters a character value even though the data type for the input parameters for the ADD_FUNCTION is number, then an error message is rendered on the user's client device 102 and the user is further prompted to enter a numeric value for the input parameter.

In “reference file validation mode”, the input parameters for the ADD_FUNCTION are provided by a reference file. In an exemplary embodiment of the present invention, the format of the reference XML file is as follows:

<object_info>
<object name=“ADD_FUNCTION”>
<type>FUNCTION</type>
<input>147</input>
<input>270</input>
<output>417</output>
</object>
<object name=“MULTIPLYBY2”>
<type>PROCEDURE</type>
<input>45</input>
<output>90</output>
</object>
</object_info>

The input parameters for the database object “ADD_FUNCTION” are extracted from the reference XML file. In an embodiment of the present invention, if the “ADD_FUNCTION” that is required to be validated is not present in the reference XML file, then the input parameters are not extracted and an error message such as “Object not present in reference file” is rendered on the client device 102.
During validation of ADD_FUNCTION by the execution engine 114, the input parameters are passed to the following query.
query: ?=call ADD_FUNCTION(?, ?);
CallableStatement cs=dbConnection.prepareCall(query);
The ‘?’ are replaced with actual values using the following queries:
cs.setInt(2, 147);
cs.setInt(3, 270);
cs.registerOutParameter(1, java.sql.Types.NUMERIC);
To execute, the following query is used:
cs.executeUpdate( );
result=cs.getInt(1);
The result is equal to 417.
On successful execution of the ADD_FUNCTION, the execution status of the ADD_FUNCTION is “PASS”. Incase of any errors in execution, the execution status assigned to the ADD_FUNCTION is “FAIL” and corresponding error message is displayed to the user via the client device 102. The execution status is used to determine the validity of the ADD_FUNCTION.

In another exemplary embodiment of the present invention, for validating an “insert trigger”, table and corresponding columns on which the insert trigger acts are first identified by the execution engine 114. In case the database selected is Oracle server, the details are obtained from the system tables “user_triggers” and “all_tab_columns”. The execution engine 114 then generates an insert statement so as to evoke the insert trigger. If the automatic validation mode is selected, then the insert statement is generated by identifying the data type of the identified table and its corresponding column. In case manual or reference file validation mode is selected, then the insert statement is generated using the input parameters provided by the one or more users or as provided in the reference file. The insert statement is then fired which leads to subsequent execution of the insert trigger. The insert trigger is then validated. For example, an insert statement such as INSERT INTO BOOK VALUES (4545, ‘ABCD’, ‘hgdf’, ‘100’) will result in implicitly calling INSERT_HISTORY table and will further insert the values provided in the insert statement into the called table. If the values are successfully inserted in the INSERT_HISTORY table then the insert trigger is assigned “pass” execution status by the execution engine 114 else the execution status assigned to the insert trigger is “fail”.

Once all the database objects are executed, the execution engine 114 provides the generated results of the validation to the reporting module 116. The generated validation results comprise execution status of each of the one or more database objects. The reporting module 116 is configured to process the results of the validation and generate one or more validation reports. The results of the validation are processed in order to present the results in a meaningful manner to the one or more users. The reporting module 116 is also configured to generate and store XML version of the one or more validation reports for future reference. In an embodiment of the present invention, the one or more validation reports include information such as, but not limited to, database name, date and time of validation, total number of objects validated, number of failed or invalid objects, object name, object type, execution status and validation mode. In an embodiment of the present invention, the one or more validation reports are in the form of, but not limited to, spreadsheets and Portable Document Format (PDF) file. In an embodiment of the present invention, the reporting module 116 provides the actual validation results and the output values that were provided in the reference file to the one or more users if the validation is performed using the “reference file validation mode”. In an embodiment of the present invention, the reporting module 116 also renders appropriate error messages to highlight the database objects that failed validation. In an embodiment of the present invention, the one or more validation reports comprise, but not limited to, graphs, pie charts and bar charts to provide the validation results in a clear and precise manner.

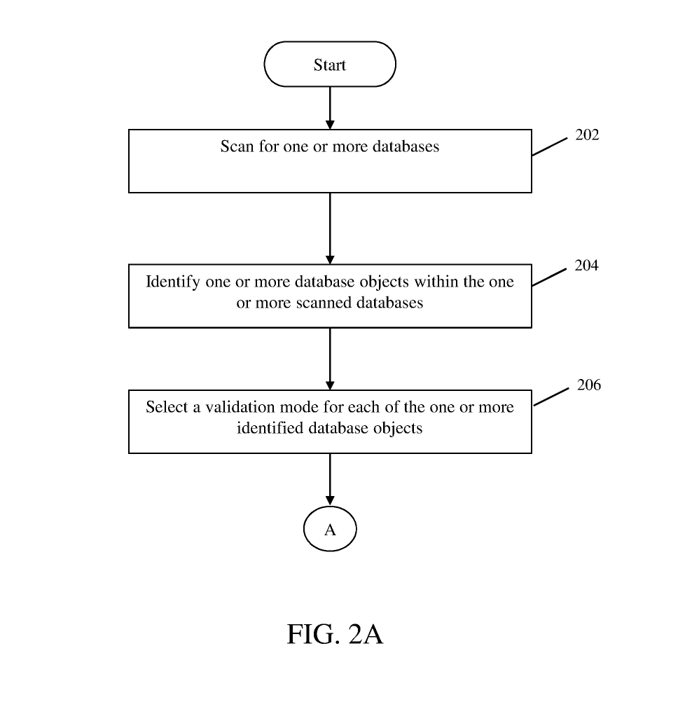

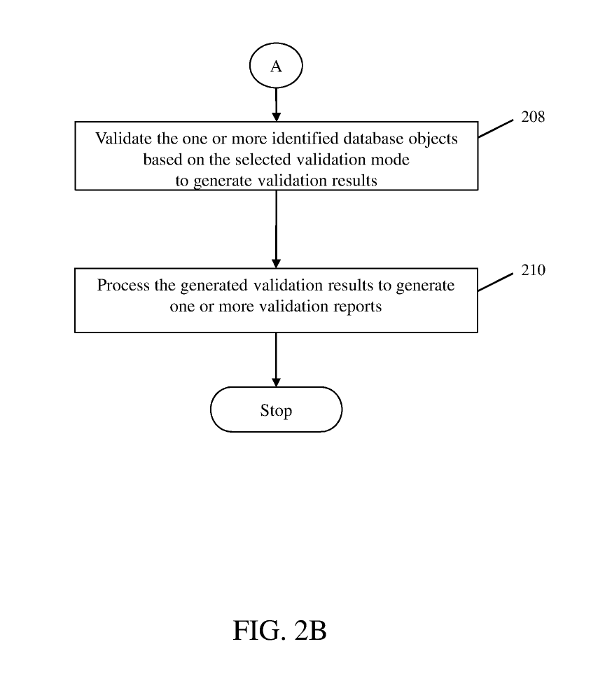

FIGS. 2A and 2B represent a flowchart illustrating a method for automatically and efficiently validating database objects, in accordance with an embodiment of the present invention.

At step 202, one or more databases associated with one or more organizations/enterprises are scanned. The one or more databases act as a repository for data associated with the one or more organizations/enterprises. In an embodiment of the present invention, the one or more databases include, but not limited to, Relational Database Management Systems (RDBMS) such as Structured Query Language (SQL) server, Oracle server, Sybase and DB2 and large databases such as Teradata. The one or more databases include one or more database objects that are required to be validated. The one or more database objects are data structures used to either store the data or reference the stored data within the one or more databases. Further, there are different types of database objects such as, but not limited to, stored procedures, functions, views, triggers, sequences, indexes and tables that are used for different purposes and functions in the one or more databases.

In an embodiment of the present invention, the one or more databases are scanned by an application residing on one or more client devices. In an embodiment of the present invention, the application is pre-installed on the one or more client devices. In another embodiment of the present invention, the application is hosted on a remote server and can be accessed by one or more users via the one or more client devices using Internet Protocol address. In an embodiment of the present invention, the one or more users provide authentication details to access the application on the one or more client devices. In an embodiment of the present invention, the one or more users include, but not limited to, testers, software developers and quality analysts involved in project development lifecycle. In an embodiment of the present invention, the one or more client devices include, but not limited to, desktops, laptops, palmtops, netbooks, mobile phones, tablets and Personal Digital Assistants (PDAs).

In an embodiment of the present invention, once the one or more databases are scanned, the one or more users select one or more databases, whose database objects have to be validated, from the one or more scanned databases. Further, the one or more users provide authentication details associated with the one or more selected databases to access and facilitate validation. In another embodiment of the present invention, the one or more users are not required to select the one or more scanned databases and control automatically proceeds to step 204.

At step 204, one or more database objects within the one or more scanned databases are identified. In an embodiment of the present invention, during operation, database schemas associated with the one or more scanned databases are first identified. The one or more database objects are then identified within the identified database schemas. In an embodiment of the present invention, the one or more identified database objects are grouped together based on type of the database object.

In an embodiment of the present invention, once all the database objects associated with the one or more scanned databases are identified, the one or more users are prompted to select the one or more identified database objects that are to be validated via the one or more client devices. In another embodiment of the present invention, the system automatically facilitates validation of all the identified database objects and may not prompt the one or more users to select the one or more database objects for validation.

At step 206, a validation mode for each of the one or more identified database objects is selected. The various validation modes that can be used for validation of the identified database objects include, but not limited to, manual, reference file and automatic validation mode. In an embodiment of the present invention, the one or more users select the validation mode for each of the one or more identified database objects. In another embodiment of the present invention, the “automatic validation mode” is automatically selected for all the database objects unless the one or more users select any other validation mode.

In an embodiment of the present invention, if the one or more users select the “manual validation mode”, then the one or more users are prompted to provide one or more input parameters of the one or more identified database objects based on data type of the one or more input parameters. In an embodiment of the present invention, various data types for the one or more input parameters include, but not limited to, number, variable character, float, date and timestamp. In an embodiment of the present invention, if the one or more users provide incorrect data type of the one or more input parameters, then an error message is rendered on the one or more client devices.

In an embodiment of the present invention, if the one or more users select the “reference file validation mode”, then the one or more users are prompted to choose and upload one or more reference files for validation. In an embodiment of the present invention, the one or more reference files are Extensible Markup Language (XML) files. In an embodiment of the present invention, the one or more references files are generated by storing information related to the one or more database objects that were validated using the “manual validation mode”. The information related to the one or more database objects stored in the one or more reference files include, but not limited to, database object type, name, input parameters entered by the one or more users and output parameters generated on validation. In an embodiment of the present invention, during the “reference file validation mode”, the one or more input parameters from the uploaded reference file are extracted and provided to the one or more users via the one or more client devices for review. The extracted one or more input parameters are also used during validation. Further, appropriate error messages are rendered on the one or more client devices if the one or more input parameters for the one or more identified database objects are not available in the uploaded one or more reference files.

In an embodiment of the present invention, if the “automatic validation mode” is selected, then one or more pre-defined functions are used to generate the one or more input parameters of one or more identified database objects based on the data type of the one or more input parameters. In an embodiment of the present invention, the one or more pre-defined functions are pre-stored sub-routines used for automatic validation of the one or more identified database objects.

In an embodiment of the present invention, during operation, the one or more databases are first queried for determining type of the one or more identified database objects to be validated. The data type for each of the one or more input parameters and one or more output parameters of the one or more identified database objects is then determined. The one or more pre-defined functions are then used for generating values of the one or more input parameters based on the determined data type.

In an exemplary embodiment of the present invention, for Oracle Server, numeric input parameters are generated using the pre-defined function “rand.nextInt(max)”, wherein “max” is the limit of the function “rand.nextInt(max)”. Similarly, a different pre-defined function is used for generating a character or a float or a date value as the one or more input parameters. In an embodiment of the present invention, the one or more users can configure the one or more pre-defined functions and modify limits assigned to the one or more pre-defined functions by accessing one or more XML files in which these limits are stored.

At step 208, the one or more identified database objects are validated based on the selected validation mode to generate validation results. In an embodiment of the present invention, if the “manual validation mode” is selected then the one or more input parameters provided by the one or more users are used for validation. In another embodiment of the present invention, if the “reference file validation mode” is selected, then the one or more input parameters extracted from the one or more reference files are used for validation. In yet another embodiment of the present invention, if the “automatic validation mode” is selected, then the one or more input parameters generated using the one or more pre-defined functions are used for validation. The one or more identified database objects are validated by executing them using the provided one or more input parameters. In an embodiment of the present invention, all the identified database objects are simultaneously executed. In another embodiment of the present invention, the one or more users have an option to selectively initiate execution of a particular type of database objects or a group of database objects.

Once the execution of the one or more identified database objects is complete, validation results are generated for each of the one or more database objects using output of the execution. The validation results comprise execution status of each of the one or more executed database objects. The database objects are considered valid if the database object is executed successfully. In an embodiment of the present invention, if the database object is successfully executed then it is assigned a “Pass” execution status. In another embodiment of the present invention, a “Fail” execution status is assigned to the one or more executed database objects that have errors and are not successfully executed.

At step 210, the validation results are processed to generate one or more validation reports. The results of the validation are processed so as to present them to the one or more users in a meaningful manner. The XML version of the one or more validation reports is also generated and stored for future reference. In an embodiment of the present invention, the one or more validation reports include, but not limited to, database name, date and time of validation, total number of objects validated, number of failed objects, object name, object type, validation status and validation mode. In an embodiment of the present invention, the one or more validation reports are in the form of, but not limited to, spreadsheets and Portable Document Format (PDF) file. In an embodiment of the present invention, the actual validation results along with the output values that were provided in the uploaded reference file are provided to the one or more users if the validation is performed using the “reference file validation mode”. In an embodiment of the present invention, appropriate error messages along with errors are rendered on the one or more client devices to highlight the database objects that failed validation. In an embodiment of the present invention, the one or more validation reports comprise, but not limited to, graphs, pie charts and bar charts to provide the validation results in a clear and precise manner to the one or more users.

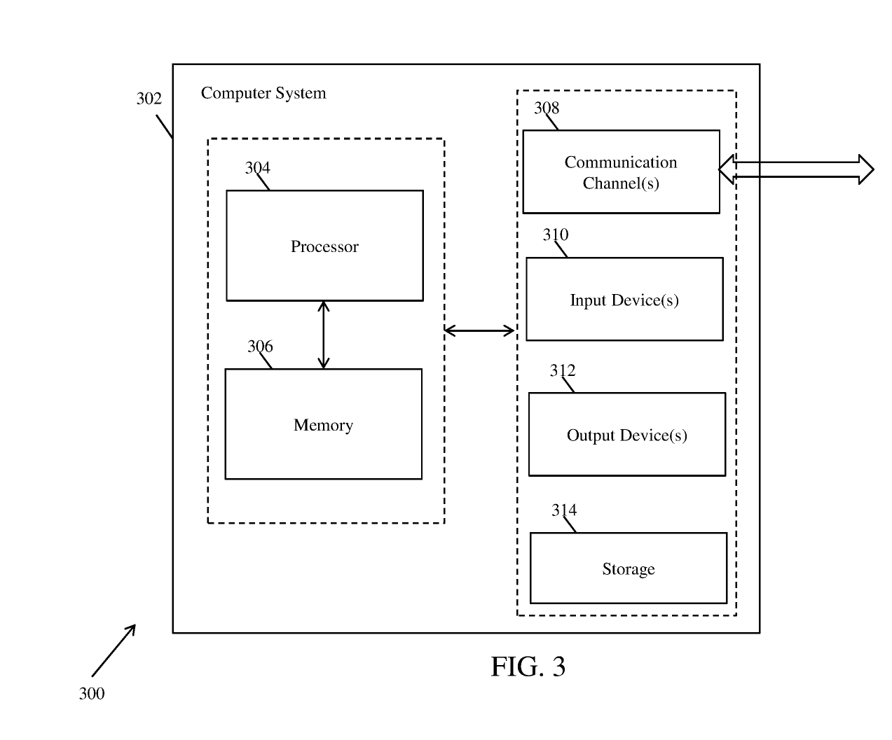

FIG. 3 illustrates an exemplary computer system in which various embodiments of the present invention may be implemented.

The computer system 302 comprises a processor 304 and a memory 306. The processor 304 executes program instructions and may be a real processor. The processor 304 may also be a virtual processor. The computer system 302 is not intended to suggest any limitation as to scope of use or functionality of described embodiments. For example, the computer system 302 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 310 may include, but not limited to, a keyboard, mouse, pen, joystick, trackball, a voice device, a scanning device, or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for validating one or more database objects, the system comprising:
an application, residing on one or more client devices, configured to establish a connection with a validation module and further configured to scan one or more databases connected to the validation module; and
the validation module comprising:
a schema look-up module configured to identify one or more database objects from the one or more scanned databases;
a parameterization module configured to facilitate selection of a validation mode and further configured to provide one or more input parameters based on the selected validation mode;
an execution engine configured to execute the one or more identified database objects using the one or more provided input parameters and generate validation results, wherein the generated validation results comprise execution status of each of the one or more executed database objects; and
a reporting module configured to generate one or more validation reports using the generated validation results.

2. The system of claim 1, wherein the one or more database objects include: stored procedures, functions, views, triggers, sequences, indexes, tables and any other database objects.

3. The system of claim 1, wherein the validation mode selected is at least one of: manual, reference file and automatic.

4. The system of claim 3, wherein the one or more input parameters are generated by the parameterization module using one or more pre-defined functions if automatic validation mode is selected.

5. The system of claim 3, wherein the one or more input parameters are extracted from a pre-stored reference file if the reference file validation mode is selected.

6. The system of claim 3, wherein the one or more input parameters are provided by one or more users if manual validation mode is selected.

7. The system of claim 1, wherein data type of the one or more input parameters include: number, float, character, variable character, date and timestamp.

8. The system of claim 1, wherein the database object is valid if the database object is executed successfully.

9. The system of claim 1, wherein the one or more client devices include desktops, laptops, palmtops, netbooks, mobile phones, tablets and Personal Digital Assistants (PDAs).

10. The system of claim 1, wherein the one or more generated validation reports include: database name, date and time of validation, number of objects validated, number of failed or invalid objects, object name, object type, execution status and validation mode.

11. A computer-implemented method for validating one or more database objects, via program instructions stored in a memory and executed by a processor, the computer-implemented method comprising:
establishing a connection with a validation module using one or more client devices;
scanning one or more databases connected to the validation module;
identifying one or more database objects from the one or more scanned databases;
selecting a validation mode;
providing one or more input parameters based on the selected validation mode;
executing the one or more identified database objects using the one or more provided input parameters;
generating validation results, wherein the generated validation results comprise execution status of each of the one or more executed database objects; and
generating one or more validation reports using the generated validation results.

12. The computer-implemented method of claim 11, wherein the one or more database objects include: stored procedures, functions, views, triggers, sequences, indexes, tables and any other database objects.

13. The computer-implemented method of claim 11, wherein the validation mode selected is at least one of: manual, reference file and automatic.

14. The computer-implemented method of claim 13, wherein the one or more input parameters are generated using one or more pre-defined functions if automatic validation mode is selected.

15. The computer-implemented method of claim 13, wherein the one or more input parameters are extracted from a pre-stored reference file if the reference file validation mode is selected.

16. The computer-implemented method of claim 13, wherein the one or more input parameters are provided by one or more users if manual validation mode is selected.

17. The computer-implemented method of claim 11, wherein data type of the one or more input parameters include: number, float, character, variable character, date and timestamp.

18. The computer-implemented method of claim 11, wherein the database object is valid if the database object is executed successfully.

19. The computer-implemented method of claim 11, wherein the one or more client devices include: desktops, laptops, palmtops, netbooks, mobile phones, tablets and Personal Digital Assistants (PDAs).

20. The computer-implemented method of claim 11, wherein the one or more generated validation reports include: database name, date and time of validation, number of objects validated, number of failed or invalid objects, object name, object type, execution status and validation mode.

21. A computer program product for validating one or more database objects, the computer program product comprising:
a non-transitory computer-readable medium having computer-readable program code stored thereon, the computer-readable program code comprising instructions that when executed by a processor, cause the processor to:
establish a connection with a validation module using one or more client devices;
scan one or more databases connected to the validation module;
identify one or more database objects from the one or more scanned databases;
select a validation mode;
provide one or more input parameters based on the selected validation mode;
execute the one or more identified database objects using the one or more provided input parameters;
generate validation results, wherein the generated validation results comprise execution status of each of the one or more executed database objects; and
generate one or more validation reports using the generated validation results.
